(19) United States
(12) Patent Application Publication
(10) Pub. No.: US 2004/0219317 A1
(43) Pub. Date: Nov. 4, 2004

(54) Process for manufacturing a flexible tubular pipe having extruded layers made of crosslinked polyethylene

(75) Inventor: John R. Belcher, Panama City, FL (US)

Correspondence Address: HAYNES AND BOONE, LLP, 901 MAIN STREET, SUITE 3100, DALLAS, TX, 75202, US

(73) Assignee: Wellstream International Limited, Newcastle upon Tyne (GB)

(21) Appl. No.: 10/762,597

(22) Filed: Jan. 22, 2004

Related U.S. Application Data
(60) Provisional application No. 60/441,788, filed on Jan. 22, 2003.

(51) Int. Cl. B32B 1/08

(52) U.S. Cl. 428/35.7; 264/485

(57) ABSTRACT

Processes for manufacturing flexible pipes having extruded layers made of crosslinked polyethylene, in which the polyethylene is crosslinked by electron beam irradiation. A flexible pipe for use in sub-sea and land-based applications having an innermost core of crosslinked polyethylene, in which the crosslinked polyethylene is cured by electron beam irradiation.

### CROSS-REFERENCE TO RELATED APPLICATIONS

This application claims the benefit of U.S. Provisional Application No. 60/441,788, filed Jan. 22, 2003, the entire disclosure of which is hereby incorporated herein by reference.

### BACKGROUND

The present embodiment relates generally to processes for curing crosslinked polyethylene for use in flexible pipes formed of multiple layers of different materials and suitable for use in subsea and land-based applications. The present embodiment also relates to such flexible pipes that include at least one layer made of a crosslinked polyolefin.

It is known to produce flexible pipes that include at least one layer of plastic and plies of armoring to provide the compressive and tensile strength necessary for subsea and land-based applications intended for oil production or other services from offshore or onshore deposits. The high strength flexible pipes with a structure having several layers, which are particularly advantageous, have diameters varying from 50 mm to 500 mm, and allowable internal pressures which may vary depending on the diameter having a minimum value of 50 bar and which may reach 1000 bar. Various plastics are used for the layers of such flexible pipes. Polyolefins, principally polyethylene, and in particular high density polyethylene (HDPE), however, undergo physicochemical attack from live crude oil.

It is known that certain properties of polyethylene can be improved by crosslinking to produce crosslinked polyethylene (PEX). Three methods are known by which polyethylene can be crosslinked, namely by irradiation, chemically by silane, or chemically by using peroxide chemistry.

For instance, U.S. Pat. No. 4,455,406 discloses that the mechanical behavior of polyethylenes for large diameter pipes can be improved by chemical crosslinking with peroxides. The chemical crosslinking method, however, requires a temperature that can prevent the polyethylene from supporting their own weight during the crosslinking process.

Also, U.S. Pat. No. 5,514,312 discloses a process for curing silane grafted crosslinked polyethylene by circulating hot water through the interior of a pipe.

Also according to U.S. Pat. No. 5,514,312, it is disclosed that the flexible pipe itself could be used to convey a fluid for supplying the heat and moisture making it possible to increase and to maintain the temperature necessary for obtaining the desired reaction in a reasonable time. According to this process, the plies of metallic wires that constitute the strength armoring of the pipe were electrically conductive and may be used as heating resistance elements.

It is difficult, however, to use these methods for crosslinking polyethylene on an industrial scale to produce flexible polyethylene pipes in part because of the large size of the pipes. Therefore, there is a need for simplified processes for manufacturing flexible pipes that include a crosslinked polyethylene layer.

### BRIEF DESCRIPTION OF THE DRAWINGS

For a more complete understanding of the present invention, reference is now made to the following descriptions taken in conjunction with the accompanying drawings, in which:

FIG. 1 illustrates an electron-beam accelerator system for producing a tubular shaped conduit having a crosslinked polyethylene layer according to one of the present embodiments.

FIG. 2 is a perspective view of one embodiment of a flexible pipe having an innermost layer prepared according to the process illustrated by FIG. 1.

FIG. 3 is a perspective view of another embodiment of a flexible pipe having an innermost layer prepared according to the process illustrated by FIG. 1

### DESCRIPTION

The present embodiment is directed to processes for manufacturing flexible pipes having extruded layers made of crosslinked polyethylene in which the polyethylene is crosslinked by electron beam irradiation, which is also referred to as X-ray curing of polyethylene. Polyethylene that is crosslinked by electron beam irradiation is also referred to as PEX-C. The present embodiment is further directed to a flexible pipe design having an innermost layer of PEX-C.

It is to be understood that the following disclosure provides many different embodiments, or examples, for implementing different features of the disclosed technology. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

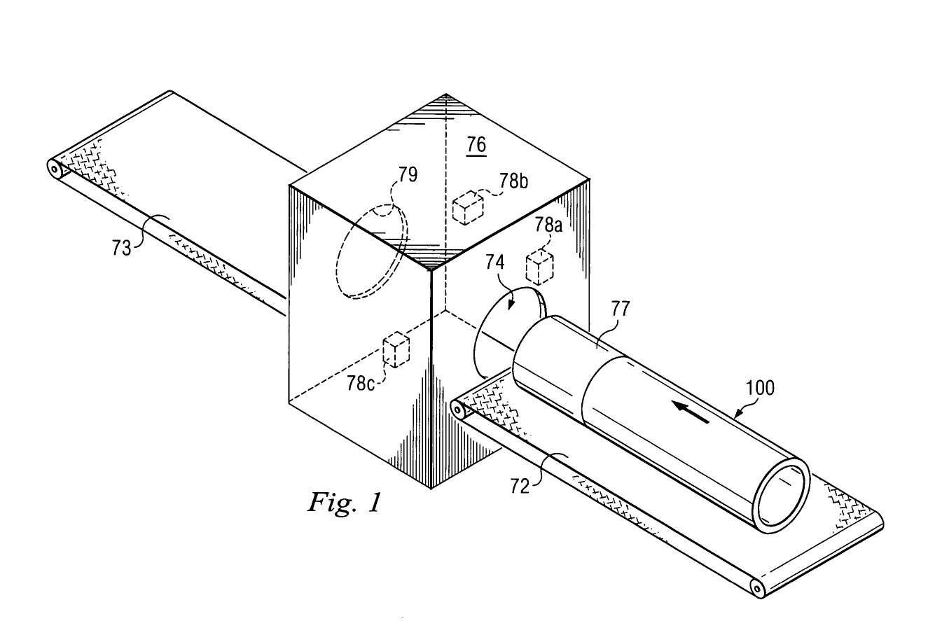

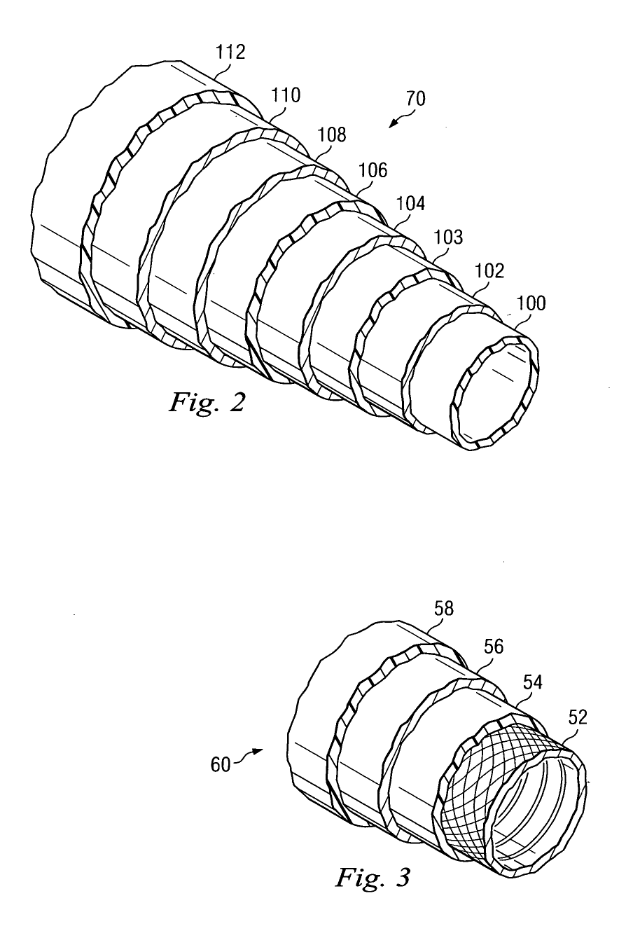

Referring now to FIGS. 1 and 2, an embodiment of a process for manufacturing a flexible pipe having at least one layer made of polyethylene that was crosslinked by electron beam radiation is illustrated.

According to this process, a tubular shaped conduit 100 of a crosslinkable material, preferably polyethylene, is manufactured according to known methods. For example, a tubular shaped conduit of a crosslinkable material can be extruded through a single screw, twin screw, or other extrusion and die assembly. As tubular shaped conduit 100 exits an extrusion assembly (not illustrated), a conveyor 72 provides the tubular shaped conduit 100 to an enclosure 76, by way of an opening 74. Preferably, the enclosure is a concrete room, although other materials are suitable as long as they provide protection against exposure outside of the enclosure to the radiation occurring inside the enclosure. To assist the feed of tubular shaped conduit 100 through the enclosure 76, a feeder pipe 77 is attached to one end of the tubular shaped conduit 100. For example, the feeder pipe 77 can be fed through opening 74 and positioned to exit the enclosure 76 at an exit 79, where a take-away conveyor 73 is operable to convey the feeder pipe 77 through the exit 79. According to one embodiment, with at least a portion of the feeder pipe 77 through the exit 79, the take-away conveyor 73 operates to convey the tubular conduit 100 through the enclosure 76, and ultimately through exit 79.

Inside enclosure 76, a plurality of electron beam accelerators are radially spaced apart and arranged so that the entire surface of the tubular shaped conduit 100 is equally exposed to electron beam irradiation therefrom. According to the embodiment illustrated by FIG. 1, three electron beam accelerators 78a, 78b, and 78c, are radially spaced apart, and are arranged about 120 degrees apart with respect to each other. Electron beam accelerators 78a, 78b and 78c are illustrated in FIG. 1 as disposed against the ceiling and opposite facing walls of enclosure 76. Electron beam accelerators 78a, 78b and 78c can be affixed in place or supported in place by methods known to those of ordinary skill in the art, as long as the electron beam accelerators are radially spaced apart and arranged so that the entire surface of a conduit will be equally exposed to electron beam irradiation therefrom.

As the tubular shaped conduit 100 passes through the enclosure 76 on the conveyor 72, the entire surface of the tubular shaped conduit 100 is equally exposed to electron beam irradiation from the electron beam accelerators 78a, 78b, and 78c. According to one embodiment, each electron beam accelerator is operated in a range of about 150 kilovolts to about 6 megavolts, with a power output capable of supplying the desired voltage. The voltage can be adjusted to appropriate levels which may be, for example, 100,000, 300,000,1,000,000, 2,000,000, 3,000,000 or 6,000,000, higher or lower. The irradiation is usually carried out at a voltage between about 3 megarads to about 35 megarads, preferably between about 8 to about 20 megarads. Further, the irradiation can be carried out conveniently at room temperature, although higher and lower temperatures, for example 0° C. to about 60° C., may also be employed.

Using electron beam irradiation as described in the present embodiments, crosslinking of the crosslinkable material comprising the tubular shaped conduit 100 takes place while the conduit 100 is exposed to the radiation generated inside the enclosure 76 by the electron beam accelerators. Accordingly, the crosslinking process according to the present embodiments is quick, as compared to peroxide-based crosslinking or silane grafted crosslinking as discussed above. Generally, it is preferred that the desired level of crosslinking is obtained in a relatively short operating duration, approximately two to three minutes, although, the time required for crosslinking is dependant on the intensity of the radiation, the length and diameter of the tubular shaped conduit, and the thickness of the layer to be crosslinked. However, when the tubular shaped conduit 100 exits the enclosure 76, it has at least some level of crosslinking. Using the present embodiment, the tubular shaped conduit 100 can be crosslinked to a gel content of at least 50%, and up to as high as 94%, which provides excellent aging properties to the tubular shaped conduit 100. The tubular shaped conduit 100 can be passed through the electron beam accelerators multiple times, if necessary, in order to increase the gel content of the crosslinked polyethylene to a desired level. In addition, more than three electron beam accelerators can be used, as long as they are arranged in a configuration such that the entire surface of the tubular shaped conduit 100 is equally exposed to the radiation.

The process for manufacturing flexible pipes having extruded layers made of crosslinked polyethylene as illustrated in FIG. 1 can also be used to crosslink layers other than polyethylene, such as poly(vinylidene fluoride) (PVDF) and other crosslinkable materials.

Once a satisfactory level of crosslinking has been achieved in the crosslinkable material comprising the tubular shaped conduit 100, a flexible pipe can be manufactured with the tubular shaped conduit 100 comprising the innermost layer of the flexible pipe. According to the present embodiments, a flexible pipe having a crosslinked material as its innermost layer is a high strength flexible pipe, having a diameter of between 50 mm to 500 mm, and allowable internal pressures of between 50 bar and 1000 bar.

Referring now to FIG. 2, a perspective view of one embodiment of a flexible pipe 70, which is illustrated in cut-away to show various layers comprising the pipe 70, is illustrated. As seen in FIG. 2, a first supporting layer 102 is wrapped around the tubular shaped conduit 100, which has been crosslinked as described with respect to FIG. 1, to provide resistance to internal pressure. According to one embodiment, the layer 102 is formed by helically wrapping a continuous metal strip, with adjacent windings being interlocked, to form a flexible layer that provides significant hoop and axial strength. One example of such a layer is found in flexible pipe commercially available from Wellstream, Inc., where the layer is referred to under the “Flexlok” trademark.

A second supporting layer 103 extends over the layer 102. According to one embodiment, second supporting layer 103 comprises an extruded polymer layer.

A third supporting layer 104 extends over the second supporting layer 103. According to one embodiment, third supporting layer 104 comprises a wrapped wire assembly, and consists of a series of wires helically wrapped around the exterior of the second layer 103 to form a first tensile armoring layer, and an additional series of wires wrapped around the first series of wires to form a second tensile armoring layer extending over the first tensile armoring layer. A suitable wire assembly is described in U.S. Pat. No. 6,363,974, the entire disclosure of which is incorporated herein by reference.

A fourth supporting layer 106 extends over the third supporting layer 104. According to one embodiment, fourth layer 106 is a protective insulative sheath formed of a foamed, or blown, polymer.

A fifth supporting layer 108 extends over the fourth supporting layer 106. According to one embodiment, fifth layer 108 is a tape that is helically wrapped over the fourth supporting layer 106. The tape can be formed of plastic or metal, and can be reinforced with glass, metal or a different type of plastic.

A sixth supporting layer 110 extends over the fifth supporting layer 108 and provides additional resistance to hydrostatic collapse and crush. According to one embodiment, the sixth layer 110 comprises a plurality of helically wrapped, corrugated and/or interlocked strips to provide additional collapse and radial compression resistance.

A seventh supporting layer 112 extends over the sixth supporting layer 110. According to one embodiment, the seventh layer 112 is an outer protective sheath extruded over the sixth layer 110 in a conventional manner.

Preferably, at least second supporting layer 103 is sealed at its ends to sustain imposed loads and maintain a fluid-tight seal. More layers, less layers, and other materials beyond those illustrated in FIG. 2 can be used to make a pipe comprising an innermost crosslinkable layer 100. The number and types of layers will vary depending at least in part on the desired application for the finished pipe. Those of ordinary skill in the art can select and apply, without unreasonable experimentation, suitable layers and materials to make a pipe such as pipe 70. The method of forming a pipe 70 can be any known to those of ordinary skill in the art, as long as the innermost layer of the pipe 70 is formed of a crosslinkable material, such as PVDF or polyethylene.

According to another embodiment illustrated in FIG. 3, a crosslinkable layer 54 is extruded onto a metal carcass 52 according to methods known to those of ordinary skill in the art. The crosslinkable layer 54 can be crosslinked by electron beam irradiation according to the process described above with respect to FIG. 1. After the crosslinkable layer 54 has been crosslinked, one or more supporting layers, such as layers 56 and 58, can be formed, layered or wrapped around layer 54 according to methods known to those of ordinary skill in the art. Such supporting layers can be any material for any purpose, including but not limited to thermosetting materials, thermoplastic materials, non-plastic materials, metal strips, tape or wires.

### Variations and Equivalents

It is understood that various methods of co-extrusion, other than those shown and described herein, may also be used to extrude a tubular shaped conduit 100 as described herein.

It is understood that shapes other than tubular can be suitable for use in the manufacture of flexible pipe, and that tubular conduit 100 can be extruded or formed in other such suitable shapes.

Additional tensile layers of wires can be provided in addition to a series of wires as described in one embodiment of third layer 104.

The relative thicknesses of the layers extending over tubular shaped conduit 100 are shown only for the purpose of example, it being understood that these thicknesses can be varied within the scope of the invention.

More or less layers than those illustrated herein, as well as materials other than those illustrated herein, can be used to make a flexible pipe comprising a tubular conduit 100 prepared according to the present embodiments.

Spatial references, such as “under”, “over”, “between”, “outer”, “inner” and “surrounding” are for the purpose of illustration only and do not limit the specific orientation or location of the layers described above.

Although only a few exemplary embodiments of this invention have been described in detail above, those skilled in the art will readily appreciate that many other modifications, changes, and substitutions are possible and intended in the foregoing disclosure. Accordingly, all such modifications, changes, and substitutions are intended to be included within the scope of this invention.

What is claimed is:

1. A process for manufacturing a flexible pipe comprising:
forming an innermost layer of a flexible pipe wherein the innermost layer comprises a crosslinkable material;
crosslinking the material comprising the innermost layer by exposing the innermost layer to electron beam radiation;
forming at least one supporting layer around the innermost layer, wherein the supporting layer comprises a material selected from the group consisting of thermosetting materials, thermoplastic materials, non-plastic materials, metal strips, tape and wires; and

2. The process of claim 1 wherein the electron beam radiation is supplied by at least three electron beam accelerators arranged so that the entire surface of the innermost layer is exposed to the electron beam radiation.

3. The process of claim 2 wherein the electron beam accelerators are radially spaced apart and arranged about 120 degrees apart with respect to each other.

4. The process of claim 2 wherein each electron beam accelerator is operated in a range of about 150 kilovolts to about 6 megavolts.

5. The process of claim 1 wherein the radiation is between about 3 megarads and about 35 megarads.

6. The process of claim 1 wherein the radiation is between about 8 megarads and about 20 megarads.

7. The process of claim 1 wherein the irradiation is carried out from between 0° C. and about 60° C.

8. The process of claim 1 wherein the crosslinking results in the innermost layer having a gel content between about 50% and 94%.

9. The process of claim 1 wherein the crosslinking of the innermost layer comprises:
passing the innermost layer through an enclosure in which at least three electron beam accelerators are arranged so as to expose the innermost layer to electron beam radiation on its surface.

10. The process of claim 9 further comprising passing the pipe through the enclosure repeatedly, until a desired level of crosslinking is achieved.

11. The process of claim 1 wherein the forming of the innermost layer further comprises coating a carcass with the innermost layer prior to the crosslinking of the innermost layer.

12. The process of claim 11 wherein the crosslinking of the innermost layer comprises:
passing the carcass with the innermost layer coated thereon through an enclosure in which at least three electron beam accelerators are arranged so as to expose the carcass with the innermost layer coated thereon to electron beam radiation.

13. A flexible pipe comprising:
an innermost layer comprising a crosslinked polyethylene layer that was crosslinked by exposure to electron beam radiation; and
at least one supporting layer around the innermost layer, wherein the supporting layer comprises a material selected from the group consisting of thermosetting materials, thermoplastic materials, non-plastic materials, metal strips, tape and wires.

14. The flexible pipe of claim 13 further comprising:
a metal carcass on which the innermost layer is formed prior to crosslinking.

15. The flexible pipe of claim 13, having a diameter of between 50 mm to 500 mm.

16. The flexible pipe of claim 13, wherein the flexible pipe has allowable internal pressures of between 50 bar and 1000 bar.
